(19) United States
(12) Patent Application Publication
(10) Pub. No.: US 2024/0204267 A1
(43) Pub. Date: Jun. 20, 2024

(54) IMPEDANCE BALANCING AND CONTINUITY ASSURANCE FOR CURRENT LIMITING ELEMENT IN PARALLEL PATH FOR PREVENTION OF THERMAL RUNAWAY PROPAGATION IN BATTERY SYSTEM, PACKS AND MODULES

(71) Applicant: BAE Systems Controls Inc., Endicott, NY (US)

(72) Inventor: Joshua P. Stewart, Vestal, NY (US)

(73) Assignee: BAE Systems Controls Inc., Endicott, NY (US)

(21) Appl. No.: 18/539,584

(22) Filed: Dec. 14, 2023

Related U.S. Application Data
(60) Provisional application No. 63/387,390, filed on Dec. 14, 2022.

(51) Int. Cl. H01M 10/42; H01M 10/48; H01M 50/204; H01M 50/249

(52) U.S. Cl. CPC H01M 10/425; H01M 10/482; H01M 50/204; H01M 50/249; H01M 2220/20

(57) ABSTRACT

A battery system, battery packs and battery modules are disclosed. The battery module comprises a plurality of cells mounted within a housing. The module has a plurality of groups of cells. Each group comprises a plurality of parallel connected cells from among the plurality of cells. The plurality of groups is connected in series. The module has a plurality of current limiting elements. Each current limiting element are electrically connected in a parallel path to one or both terminals of cells which are parallelly connected. The current limiting elements may be integrated in or separate from busbars which are connected to terminals of the cells. Impedance balancing is provided to the parallel fusing scheme to improve the overall reliability of the battery module. The battery module configuration allows for continuity assurance testing of the parallel connections to ensure detection of blown fuses or broken connections in the module.

### CROSS REFERENCE TO RELATED APPLICATIONS

This disclosure relates to and claims the benefit of U.S. Provisional Patent Application No. 63/387,390, filed Dec. 14, 2022, the whole contents and disclosure of which are incorporated by reference as if fully set forth herein.

### FIELD OF THE DISCLOSURE

This disclosure relates to battery modules having a plurality of cells, where cells are parallelly connected in groups, which are serially connected to form the module, and where modules may be connected in series to form a pack and the packs may be connected in parallel to form a battery system. More particularly, this disclosure relates to a current balancing scheme when protecting against thermal runaway in the modules, packs and battery systems.

### BACKGROUND

A Battery module is comprised of a plurality of cells. The cells may be electrically connected in parallel to form a group. Each group may be connected in series. However, each cell may be susceptible to an event, which may be thermal, electrical, or mechanical, which leads to spontaneous heat generation and rapid self-heating, emission of debris, smoke, and flames, also known as thermal runaway. The event in one cell may spread to another cell and propagate though the module and subsequently from module-to-module etc. . . . This spreading of thermal runway from cell to cell is known as “propagation” of thermal runaway.

There are several modes of “propagation”. One mode may be heat transfer from cell to cell, either through the interstitial material or air gap, through a busbar connected to the cell and other cells, or through any other conduction path between cells. Insulating tape, tubes, paper, or plates may be used to provide a heat transfer barrier. The insulating tape may be mica tape.

Another mode is direct impingement of flame or heated material from one cell to another. The event may include a release of ejecta and flames from a designed cell vent, or from a pin hole forming in any location on the cell. The flame or ejecta may subsequently impinge on another cell, leading to propagation of thermal runaway. Some systems may use ceramic papers, insulating foams, and other materials to provide a barrier to these flames and ejecta.

Another mode of thermal runaway propagation is heating of the cell or cell group due to a short circuit event in a cell or an ejecta-created path which converts electrical energy into thermal energy. The cells in parallel with the shorted cell discharge through the short, producing ohmic heating and sometimes arcing. This heating can sustain flames and inject enough heat into the affected cells to result in propagation. Aspects of this disclosure pertain to mitigating this mode of thermal runaway propagation.

Certain battery modules have current limiting elements within each cell, or in the busbar attached to each cell in the series path. These individual cell level current limiting elements may mitigate propagation of thermal runaway due to parallel short circuit current. However, the use of current limiting elements at the cell level increases the resistance and voltage drop (and losses) in the cell under normal operation because these fuses limit current in the series path. This reduces the overall performance of the battery module, pack, and system.

### SUMMARY

Accordingly, aspects of the disclosure provide current limiting elements, either passively or actively, mitigating thermal runaway propagation by limiting short circuit current in the parallel path within a cell group, without limiting the normal operating charge/discharge current in the series path and further adds impedance balancing to the parallel fusing scheme to improve reliability.

Disclosed is a battery module which comprises a plurality of cells, a plurality of groups of cells and a plurality of current limiting elements. The plurality of cells is mounted with a cell housing. The cell housing has a plurality of openings for a corresponding cell. Each group of cells comprises a plurality of parallel connected cells from among the plurality of cells. The plurality of groups is connected in series. Each current limiting element is electrically connected in a parallel path to one or both terminals of cells which are parallelly connected and further adds impedance balancing to the parallel fusing scheme to improve reliability.

In an aspect of the disclosure, the battery module further comprises busbars connecting cells. The busbars may comprise a first set of busbars and a second set of busbars. The first set of busbars and the second set of busbars are connected to terminals of the cells. In an aspect of the disclosure, the plurality of current limiting elements may be integrated into first set of busbars, the second set of busbars or both the first set of busbars and the second set of busbars. In an aspect of the disclosure, each cell has a first end and a second end. In an aspect of the disclosure, the cell terminals, e.g., positive and negative terminals may be positioned on different ends of the cells. The first set of busbars may be positioned on the first end of the cells. In an aspect of the disclosure, the second set of busbars may be positioned on the second end. In accordance with aspects of the disclosure, the plurality of current limiting elements may be connected to both terminals of the cells and integrated into both the first set of busbars and the second set of busbars.

The plurality of current limiting elements according to aspects of the disclosure is configured to prevent thermal runaway from propagating from one cell to another cell.

In some aspects of the disclosure, the current limiting elements may be passive elements such as a fuse or a circuit breaker. Each fuse may connect adjacent parallelly connected cells and according to aspects of the disclosure, each fuse may be offset with the openings in the housing.

In an aspect of the disclosure, the addition of impedance balancing to the parallel fusing scheme improve reliability by enabling a short circuit current seen by each fuse for the same group to be the same for all of cells within the group.

In a further aspect, to increase reliability, in association with a respective group of parallel connected cells, a wire connection is provided that provides impedance balancing by limiting current in the parallel direction while not limiting current in the series path. This impedance balancing approach ensures the balancing of parallel short circuit current to every cell in the case of thermal runaway wherein a short circuit current seen by each fuse for the same group is the same for all of cells within the group.

Further to the impedance balancing aspect, to increase reliability, the wire connection providing impedance balancing within a group connects a first fuse of a parallel connected cell to a last fuse of the parallel connected cell to provide a closed loop connection of all the fuses for all the cells in the group.

Further to the impedance balancing aspect, an active switch is provided to break up the closed loop in order to provide for a continuity check of all the fuses within a parallel connected cell group.

Further to the impedance balancing aspect, a wire trace connection is provided to provide for a continuity check of all the fuses within a parallel connected cell group without having to break up the closed loop.

According to one aspect, there is provided a battery module. The battery module comprises: a plurality of cells mounted within a housing, the housing having a plurality of openings respectively for a corresponding cell; a plurality of groups of cells, each group comprises a plurality of parallel connected cells from among the plurality of cells, where the plurality of groups is connected in series; and a plurality of current limiting elements, each current limiting element being electrically connected in a parallel path to one or both terminals of cells which are parallelly connected; and a passive current limiting element associated with a corresponding group of cells, the passive current limiting element connected in parallel to the plurality of electrically connected current limiting elements in the parallel path.

In accordance with a further aspect, there is provided a busbar for a battery module having a plurality of battery cells. The busbar comprises: a first conductive leg structure having a plurality of tab elements, each respective tab element having a first portion adapted to electrically connect a respective first type terminal of a respective first battery cell and a second portion adapted to electrically connect a respective second type terminal of a second battery cell to form a battery cell group comprising parallel-connected battery cells; the first conductive leg structure further comprising plural integrated current limiting fuse portions, an integrated current limiting fuse portion connecting a tab element to form a series connection of alternating tab elements and integrated current limiting fuse portions connected therebetween; and a second conductive leg structure adapted to connect to the first conductive leg structure in parallel to form a closed loop structure, the second conductive leg structure additionally comprising an integrated fuse structure.

In accordance with a further aspect, there is provided a method for testing a battery module. The method comprises: applying a test signal to one end of a passive current limiting element associated with a corresponding group of cells of a plurality of groups of cells mounted within a battery module housing, each group of cells comprising a plurality of parallel connected cells from among the plurality of cells, where the plurality of groups of cells is connected in series, each corresponding group of cells having a corresponding plurality of current limiting elements, each current limiting element being electrically connected in a parallel path to one or both terminals of cells which are parallelly connected, the passive current limiting element connected in parallel to a plurality of electrically connected current limiting elements in the parallel path, the test signal for testing the parallel plurality of current limiting elements electrically connected in the parallel path; and sensing, using a sensing circuit connected to the terminal of a first current limiting element, a signal flowing through the plurality of electrically connected current limiting elements in the parallel path responsive to the applied test signal, the signal indicating blown one or more of: a blown current limiting element or a broken connection in the parallel path.

Further to this aspect, the passive current limiting element electrically connects a terminal of a first current limiting element to a terminal of a last conductive limiting element in the parallel path.

Further to this aspect, the method includes balancing, using the passive current limiting element, a distribution of current among cells of a corresponding group of parallel-connected cells in response to a short circuit of a cell of the corresponding group of parallel-connected cells to avoid the propagation of thermal runaway to adjacent cells by reason of short circuit current through a cell.

### BRIEF DESCRIPTION OF DRAWINGS

FIG. 1 illustrates a schematic diagram of a battery module with thermal runaway protection in accordance with aspects of the disclosure;

FIG. 2 illustrates a busbar with an integrated fuse in the parallel path in accordance with aspects of the disclosure;

FIG. 3A illustrates an example of a first set of busbars with fuses where a second set of busbars are unfused in accordance with aspects of the disclosure;

FIG. 3B illustrates an example of a first set and a second set of busbars with fuses in accordance with aspects of the disclosure;

FIG. 4A illustrates an exploded view of another example of busbars with fuses in accordance with aspects of the disclosure;

FIG. 4B illustrates another view of the same busbars in FIG. 4A in accordance with aspects of the disclosure;

FIG. 4C illustrates a close up view of FIG. 4B showing the connections in accordance with aspects of the disclosure;

FIG. 5 illustrates an example of the thermal runaway protection in accordance with aspect of the disclosure when one of the cells in a group of parallel connected cells has an internal short;

FIG. 6 illustrates an example of a busbar with integrated fuse after the integrated fuse has blown in accordance with aspects of the disclosure to prevent thermal runaway;

FIG. 7 illustrates another example of a busbar with an integrated fuse in the parallel path connected to groups of cells in accordance with aspects of the disclosure;

FIG. 8 illustrates an example of the busbar of FIG. 7 after the integrated fuse has blown in accordance with aspects of the disclosure to prevent thermal runaway;

FIGS. 9A-9D depict a comparison of exemplary battery cell circuit configurations without an impedance balancing element (FIGS. 9A-9B) and with an impedance balancing element (FIGS. 9C-9D) for increasing reliability of multiple cell battery packs;

FIG. 10 shows schematic diagram of a power cell (e.g., battery) module with thermal runaway protection and impedance balancing in accordance with aspects of the disclosure;

FIG. 11 shows circuit module configured as the circuit module of FIG. 10, however including a normally closed active switch device to connect the impedance balancing wire connection to the respective parallel connected fuses of the cell group;

FIG. 12 depicts the circuit module similar to the circuit module of FIG. 10 for providing continuity assurance according to a second embodiment, however, is passive, by not breaking the conductive loop formed by the impedance balancing wrap around wire in each group;

FIG. 13A illustrates an example busbar design 260 including an impedance balanced parallel fuse configuration with provision for continuity assurance verification;

FIG. 13B illustrates an example busbar design according to an alternate embodiment corresponding to the embodiment of FIG. 11 that includes an impedance balanced parallel fuse configuration with provision for continuity assurance verification through active switch device;

FIG. 13C shows a combined assembly of a cell housing having a plurality of power cells and configured to include plural busbar with fuse structures of FIG. 13A or the busbar fuse structure 261 of FIG. 13B;

FIG. 13D shows a physical connection of busbars, each busbar including a serial connection of tabs connected in serial by fuse elements, each of the tabs connecting cells in parallel along two rows;

FIG. 14A illustrates a passive test method using the busbar design of FIG. 13A, e.g., according to the embodiment of FIG. 12, for continuity assurance testing;

FIG. 14B illustrates a passive test method using the busbar design according to the embodiment of FIG. 13A for continuity assurance, however showing an instance of one fuse being blown, i.e., a broken or open fuse; and

FIG. 15 illustrates a block diagram of a control system for conducting a continuity assurance testing in accordance with aspects of the disclosure.

### DETAILED DESCRIPTION

A battery module 100 may comprise a plurality of cells 25. The cells 25 may be connected in parallel to form a cell group 10. Cell groups 10 may be connected in series to form the battery module 100. The plurality of groups 1-N are connected to the module terminals 75. The modules 100 may be connected in series to form a battery pack via the module terminals 75. The battery pack may be connected in parallel with other battery packs to for a battery system.

The number of cells 25 connected in a group 10, the number of groups 10 connected in series to form the module 100, the number of modules 100 connected in series to form a pack and the number of packs connected in parallel to for the battery system may be application specific based on the current and voltage needs of the application. Higher voltage applications such as powering a propulsion system for a vehicle may require many modules and packs.

The battery module 100 (packs and system) may be used for many different applications. For example, the battery module 100 (packs and system) may be installed in a vehicle. The vehicle may be a personal vehicle, such as a scooter, car, motorcycle and truck or a commercial vehicle such as a truck or bus, a maritime vehicle has as a boat or submarine or a military vehicle such as a tank. In other aspects of the disclosure, the battery modules 100 (packs and system) may be used in an airplane or a helicopter. The battery module 100 may be used for propulsion power (main or supplemental) or auxiliary power for accessories.

In other aspects of the disclosure, the battery module 100 (packs and system) may be used for tools, industrial machinery and assembly lines, hand-held power tools such as drills and saws, lawn equipment such as string trimmers and blowers, home cleaning equipment such as vacuum cleaners, or other home appliances.

In accordance with aspects of the disclosure, currently limiting elements, whether passive 50, are positioned within a parallel path between parallelly connected cells. These current limiting elements 50 react to an event and mitigate propagation, protecting cells 25 within the module 100 from thermal runaway. The current limiting element may be connected to the positive terminal of a cell, the negative terminal of a cell, or both the positive terminal of a cell and the negative terminal of the cell.

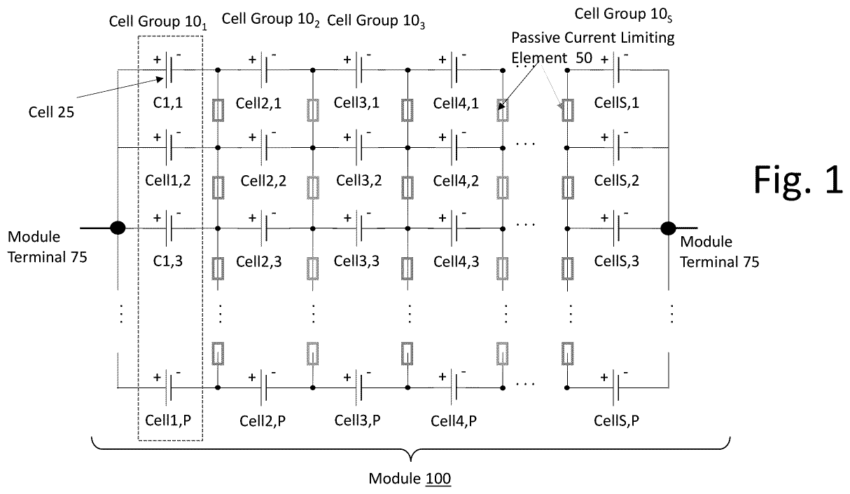

FIG. 1 illustrates an example of protection for thermal runaway using a passive current limited 50 in accordance with aspects of the disclosure. In FIG. 1, P cells are connected in parallel to form a cell group 10, where P is the number of parallelly connected cells. S groups of cells are connected in series, where S is the number of groups connected in series. The module 100 has S*P number of cells 25. For purposes of the description, the cell may be identified by C1,1 through CellS, P. The first number/letter refers to the group and the second refers to the cell within the group so for example, C1,3 is the third cell in the first group. The cells 25 are connected between module terminals 75. A passive current limiting element (current limiter 50) is positioned in the parallel path of between the parallelly connected cells 25. The fuses do not limit current in the series path. In FIG. 1, a passive current limiting element 50 is connected to both the positive and negative terminals of the cells. However, as noted above, the passive current limited element 50 may only be connected to one of the terminals and not both.

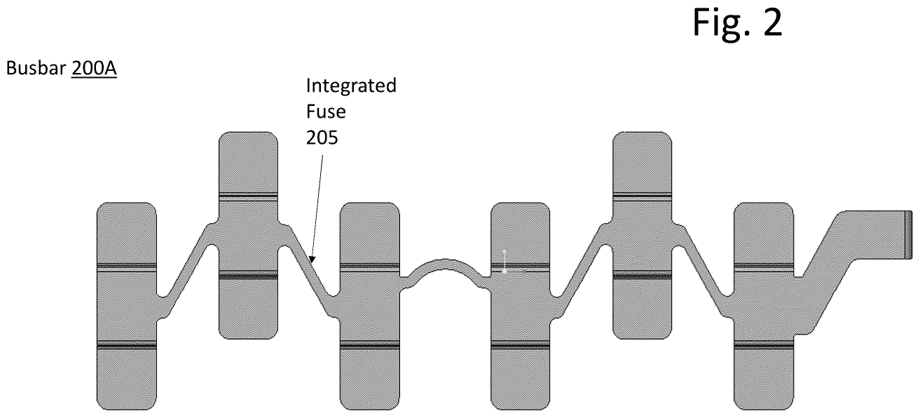

In some aspects of the disclosure, the passive current limiting element 50 may be fuse. The fuse may be made of a conductive material. In some aspects of the disclosure, as shown in FIG. 2, the fuse 205 may be integrated into a busbar 200A. A busbar is a structure, or assembly of sub-structures, which make electrical connections between elements.

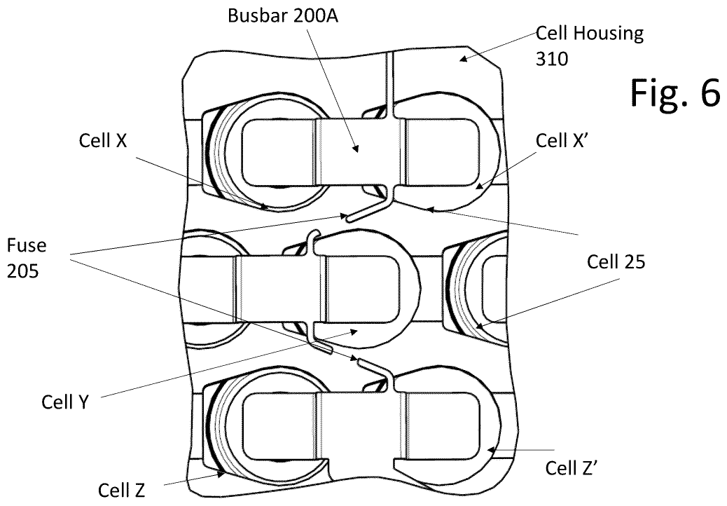

The length of the fuse may be based on the spacing between adjacent parallel connected cells (e.g., C1, 1 and C1, 2). The fuse may be designed to force current flowing into a narrow geometry (width) to produce melting (cracking/breaking) to disconnect under the event conditions (such as thermal runway initiated parallel short circuit currents) such as shown in FIG. 6. In the example shown in FIG. 6, a thermal event occurred in Cell Y. As illustrated in the example, the fuse 205, connected in the parallel path between Cell Y and Cells X, X′, Z, Z′, broke thus electrically disconnecting Cell Y from its adjacent cells in the parallel direction. FIG. 6 shows the integrated fuse after it has blown due to the thermal event. Therefore, any thermal event occurring in Cell Y is not spread to the adjacent Cells X, X′, Z, Z′ (in the parallel direction) in the group(s) connected to the busbar 200A. FIG. 6 is a partial view of the busbars 200A and cell groups 10 connected to the same.

The integrated fuse 205 may be a thinner portion of the busbar 200A. The integrated fuse 205 may be fabricated with the same material as the busbar 200A. For example, the integrated fuse 205 may be made from aluminum. However, the material used for the integrated fuse 205 is not limited to aluminum and other conductive materials may be used, such as but not limited to copper and nickel. The fuse may also be welded to the busbar or mounted to the same to form the integration.

The fuse bulk temperature T is the melting temperature of the fuse. When this temperature is reached, the electrical connection is broken. T is defined by the following equation

$$T = {T}_{0} + Δ T where {T}_{0} is initial temp ( ° C . ) \qquad ( 1 )$$

and
ΔT is defined by

$$Δ T = φ {I}^{2} t \qquad ( 2 A )$$

$$or$$

$$Δ T = \frac{Q}{m * {C}_{p}} t \qquad ( 2 B )$$

Q is loss (W), m is bulk mass of fuse (kg), I is the parallel cell short circuit current and t is time. The parallel cell short circuit is a system parameter based on the design of the module 100. T is a reaction time (melting time and isolation time).

Q and φ are based on the material properties and design.

$$φ = \frac{ρ}{{W}^{2} {H}^{2} {DC}_{p}} \qquad ( 3 )$$

ρ is the resistivity of the material. W is the width of the fuse (meters); H is the height (meters), and D is the density of the material (kg/m³). Cₚ is bulk specific heat capacity (J/kgK).

$$ρ = {ρ}_{ref} [ 1 + α ( T - {T}_{ref} ) ] \qquad ( 4 )$$

ρ_{ref} is the reference resistivity of the fuse base material at a reference temperature, T_{ref} (C), and α is the temperature coefficient of electrical resistivity (1/° C.)

Q is the heat generated in the fuse by the parallel short circuit current in Watts (W)

$$Q = {I}^{2} R \qquad ( 5 )$$

The bigger the cross-sectional area of the fuse, the longer it takes to reach the fuse bulk temperature and isolate a cell 25. For example, an aluminum fuse with a length of 10 mm and a parallel cell short circuit current of about 20A and a cross-sectional area of about 0.7 mm² will melt and isolate in about 30 seconds, whereas the same fuse with a cross-section area of about 0.3 mm² will melt and isolate in less than 10 seconds (for the same length and parallel cell short circuit current).

A higher parallel cell short circuit current will cause the same fuse (cross-sectional area and length) to melt and isolate quicker. For example, an aluminum fuse with a length of 10 mm and a cross-sectional area of about 0.6 mm² will melt and isolate in about 60 seconds for a parallel cell short circuit current of about 12A, whereas the same fuse will melt and isolate in about 10 second with a parallel cell short circuit current of about 30A.

The target time required to isolate (melt) may be based on the mechanical and electrical design of the module, and the application and critically of the power function. Certain module designs may be able to tolerate a cell short circuit current longer than other designs. For example, a module design with large separation between cells would tolerate longer fuse times and therefore extended short circuit cell heating. Certain applications may be able to tolerate a cell short current longer than other applications. For example, certain applications may allow for t to be over 1 minute or 2 minutes. However, other applications may dedicate that the isolation to prevent thermal runaways is less than 10 seconds.

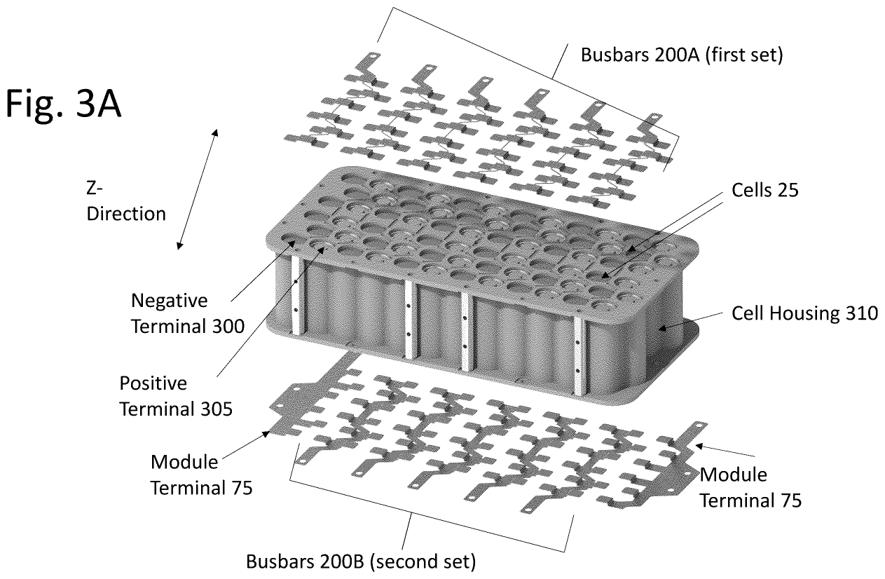

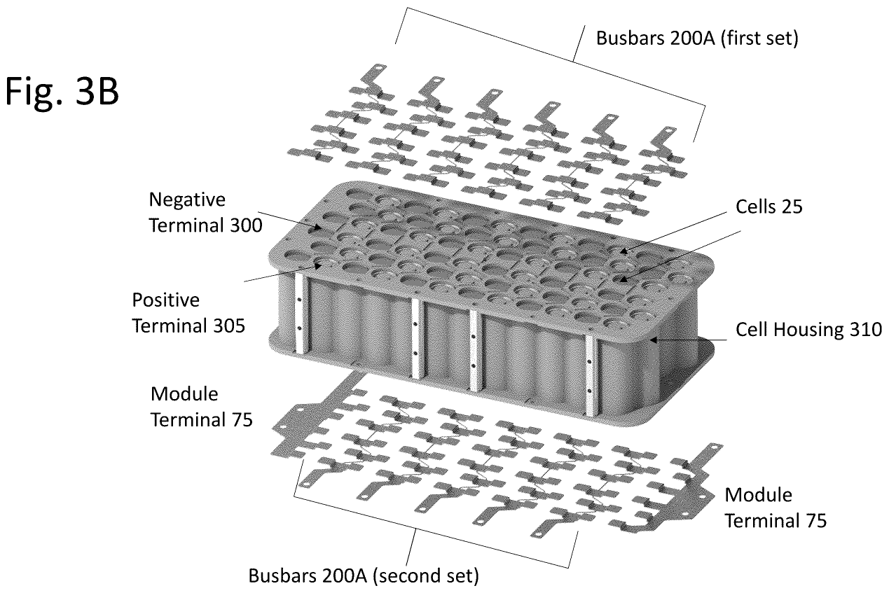

In an aspect of the disclosure, the cells 25 may be arranged in a cell housing 310. The cell housing 310 may have a plurality of openings extending in the z-axis direction (Z-direction)(shown in FIG. 3A). The cell 25 and corresponding opening may be cylindrical. However, the cell 25 is not limited to being cylindrical and cells may have a different shape. Each cell 25 has a positive terminal 305 and a negative terminal 300. In some aspects of the disclosure, the positive terminal 305 may be at a first end in the z-direction and the negative terminal 300 at a second end of the cell in the z-direction. The cells 25 may be positioned within the openings of the cell housing 310 in different orientations. For example, the cell 25 may positioned with the positive terminal 305 facing a first direction and another cell 25 may be positioned with the positive terminal 305 facing a second direction opposite of the first direction. In some aspects of the disclosure, the direction may alternate. For example, as shown in FIG. 3A, a first row of cells has its positive terminal 305 facing a first direction and the second row of cells has its positive terminal 305 facing a second direction opposite to the first direction.

FIG. 3A illustrates an exploded view showing an example of a first set of busbars 200A having integrated fuses 205 and a second set of busbars 200B not having the integrated fuses (or any fusing). In this aspect of the disclosure, only the positive terminal 305 or negative terminal 300 of a cell 25 has the fuse 205 in its parallel path between parallelly connected cells 25. In this configuration, a busbar 200A is in connection with 12 cells: parallelly connecting two sets of 6 cells and also serially connecting the two sets of cells. In the first row, the busbar 200A is connected to the negative terminal 300 and in the second row, the busbar 200A is connected to the positive terminal 305.

In this configuration, on the opposite side of the cells 25 in the z direction, the second set of busbars 200B are offset by a row with respect to the first set of busbars 200A. For example, a busbar 200B is connected to cells 25 in the second row and third row. This busbar 200B is connected to the negative terminal 300 of the cells in the second row and the positive terminal 305 of the cells in the third row.

The module terminal bars (75) are also shown in FIG. 3A.

The busbars 200A and 200B also have an opening on one end. This opening is for connecting a respective busbar to a battery management system (BMS) (not shown) for cell balancing and cell voltage monitoring.

In other aspects of the disclosure, all the busbars (both a first set and a second set) (except the module terminal bars 75) may have fuses in the parallel path between parallel connected cells as shown in FIG. 3B. It is noted that in this configuration, the first row of cells and the last row of cells only has one of the busbars 200A connected to the cells and the other side is connected to the module terminals 75 and thus, only one terminal has the integrated fuse in the parallel path between the parallel connected cells.

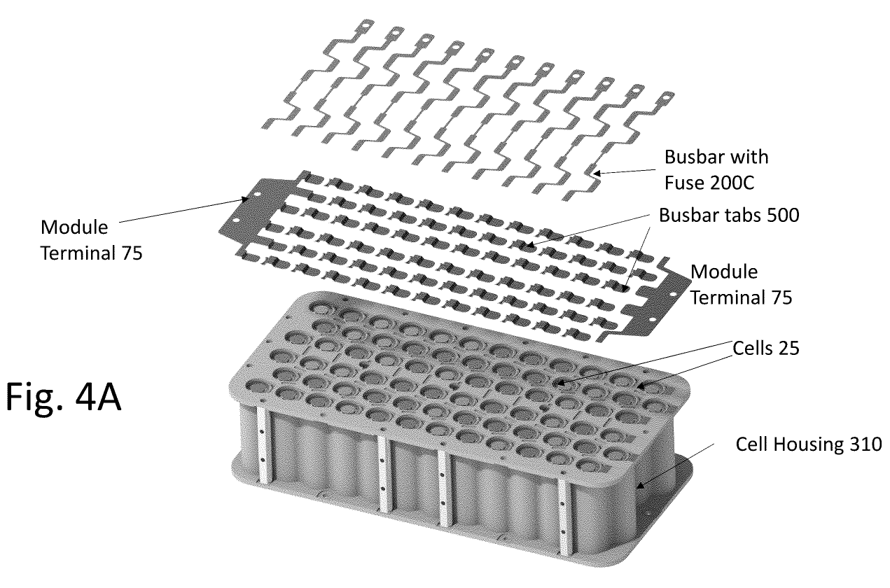

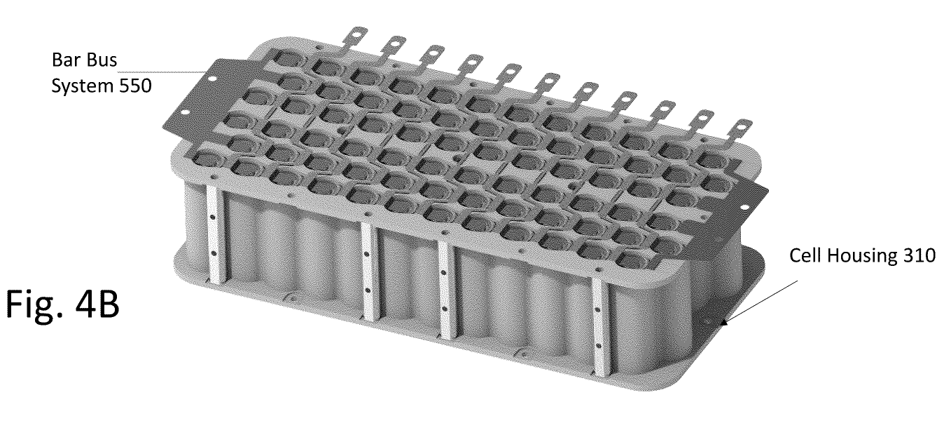

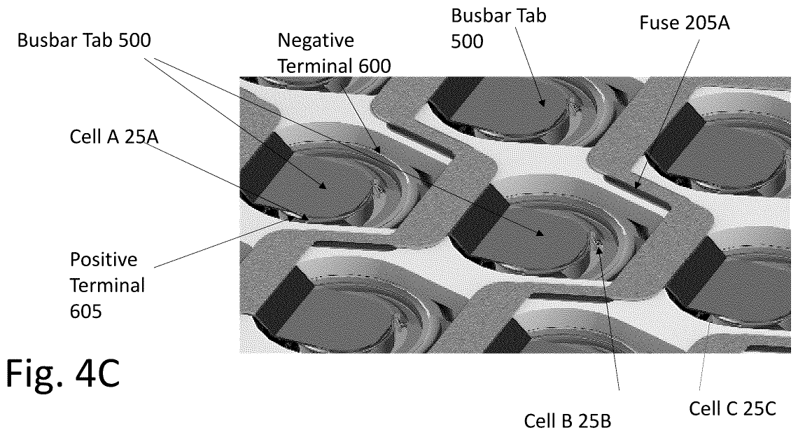

In other aspects of the disclosure, instead of the positive terminal 305 and the negative terminal 300 of a cell 25 being on different sides of the cell 25 in the z-direction, the positive terminal 605 and the negative terminal 600 may be on the same side in the z-direction such as shown in FIGS. 4A-4C.

As shown in FIG. 4C, the positive terminal 605 may be centrally located on the cell 25, e.g., a central button. The negative terminal 600 may be located on the circumference of the cell can. For example, the negative terminal 600 may be a ring around the edge of the cell 25. There may be air space between the positive terminal 605 (button) and the negative terminal 600 (ring).

The cells 25 may be serially connected via busbar tabs 500. The busbar tabs 500 may be connected to terminals of different cells. For example, cell A may be serially connected with cell B via a busbar tab 500 where the tab is connected to the negative terminal 600 of cell A and the positive terminal 605 of cell B. Similarly, a third cell may be serially connected to cell A and cell B (Cell C) via a second busbar tab 500 connecting the negative terminal 600 of cell B and the positive terminal 605 of cell C. The cells 25 in the first row and the last row of the module 100 are connected to the module terminals 75, respectively as shown in FIGS. 4A (exploded view) and 4B.

The parallel path between the cells 25 (parallelly connected cells) may be created by a busbar with fuse 200C as shown in FIGS. 4A-4C. The busbar with fuse 200C may be welded (or any other method of joining) to the busbar tabs 500 to form an electrical connection. The busbar with fuse 200C may have a meandering path that does not overlap with the openings in the cell housing 310. When connected to the busbar tabs 500, the fuse 205A is in the parallel path between parallelly connected cells. FIG. 4C shows the narrow section or bridge between adjacent cells which is the fuse section (fuse 205A) of the busbar with fuse 200C. The width and the height of the narrow section or bridge may be determined as described above and set based on a target response time and parallel cell short circuit current. The length may be based on the cell 25 arrangement within the module. The busbars with fuse 200C also have an opening on one end. This opening is for connecting a respective busbar with fuse to a battery management system (BMS) (not shown) for cell balancing and cell voltage monitoring.

The busbar with fuse 200C, the busbar tabs 500 and the module terminals 75 collectively form the busbar system 550 for the module forming the series and the parallel connections.

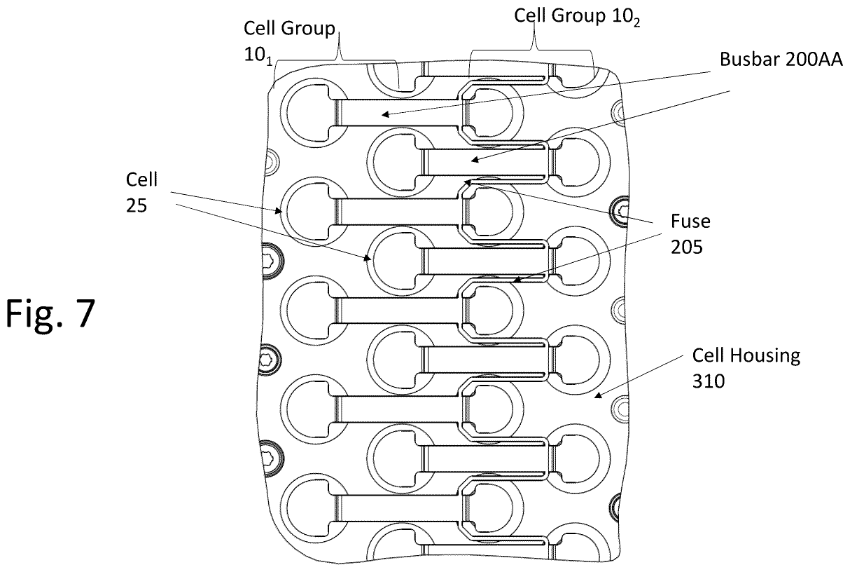

FIG. 7 illustrates a partial view of another example of a busbar 200AA with an integrated fused 205 in accordance with aspects of the disclosure. In an aspect of the disclosure, cells 25 in a cell group 10 may be arranged in multiple rows of cells and is not limited to being arranged in a single row. For example, as shown in FIG. 7, a cell group 10₁ has cells 25 arranged in two rows and cell group 10₂ has cells 25 also arranged in two rows. Thus, the busbar 200AA illustrated in the example in FIG. 7 may be connected to cells 25 in four rows (to connect the two cell groups 10₁ and 10₂). A cell group 10 may have cells from any number of adjacent rows and are not limited to the examples depicted. In FIG. 7, the fuse 205 has a C-shape and goes partially around the periphery of the cell 25. The fuse 205 is in the parallel path of parallelly connected cells 25.

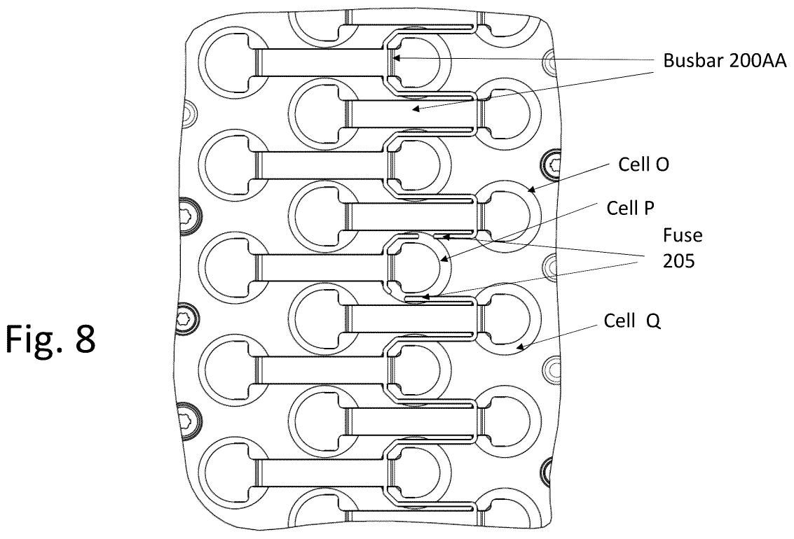

FIG. 8 illustrates an example of the fuse 205 after it has blown in response to a thermal event. In the example illustrated in FIG. 8, the thermal event occurred in Cell P. As illustrated, the fuse 205 in the parallel path of Cell P broke in two places, electrically disconnecting cell P from the parallel path in the cell group 10₂. Since Cell P is disconnected (in the parallel direction), the thermal event will not spread in the parallel direction to the adjacent cells Cell O and Cell Q in the cell group 10₂.

The passive current limiting element 50 in accordance with aspects of the disclosure is not limited to a “bar” form. In other aspects of the disclosure, the fuse may be a wire connected in the parallel path between parallel connected cells. For example, busbar tabs 500 may be used to create the serial connection between cells 25 such as shown in FIGS. 4A-4C. However, wires may be electrically connected to the busbar tabs 500 instead of the busbar with fuse 200C to make the parallel connection. The wire may be a gage wire and wire bond. In other aspects of the disclosure, the fuse may be embedded in a printed circuit board (PCB). The PCB may be rigid or flexible. The fuse may be a flexible or rigid trace in the PCB.

Once again, the height and width of the wire or trace may be determined as described above and set based on a target response time and parallel cell short circuit current. Additionally, the height and width of the fuse may depend on the material used for the conductive element of the wire or trace.

The length may be based on the cell 25 arrangement within the module.

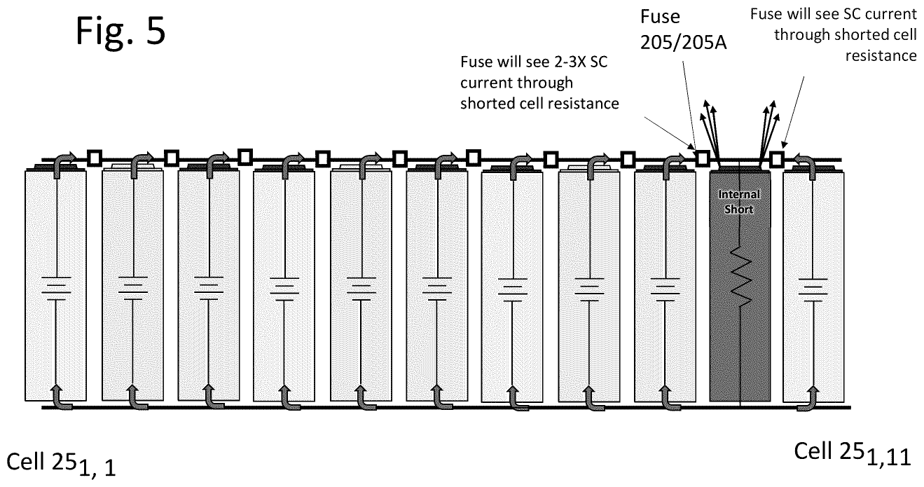

FIG. 5 illustrates an example of current paths when one of the parallelly connected cells in a group has a short. As illustrated the group (e.g., group 1) has 11 cells connected in parallel Cell 25_{1, 1} through Cell 25_{1, 11}. The amount of current seen by the fuse 205/205A (or a separate fuse) may depend on which cell 25 in the group 10₁ had the short. In this case, where cell 25_{1,10} has the short, the fuse between cell 25_{1, 9} and 25_{1, 10} will see the current flow from cells 25_{1,1}-25_{1,9}. Thus, the fuse will see 2×-3× more parallel cell short circuit current and will break before the fuse between cell 25_{1,10} and 25_{1,11}, which only see the current from cell 25_{1,11} (when all of the fuses have the same fusing properties, e.g., length, width and height). The lines projecting from cell 25_{1,10} represent ejecta which may be caused by the short.

In other aspects of the disclosure, to balance the current path in a case of a short, the end the cells 25 within a specific group, e.g., 10_{1,1} and 10_{1,11} may be connected via a fused wire to provide a current path. In this case, it would not matter which cell 25 within the group 10 had the short, each fuse 205/205A (or a separate fuse) would see the same parallel cell short circuit current.

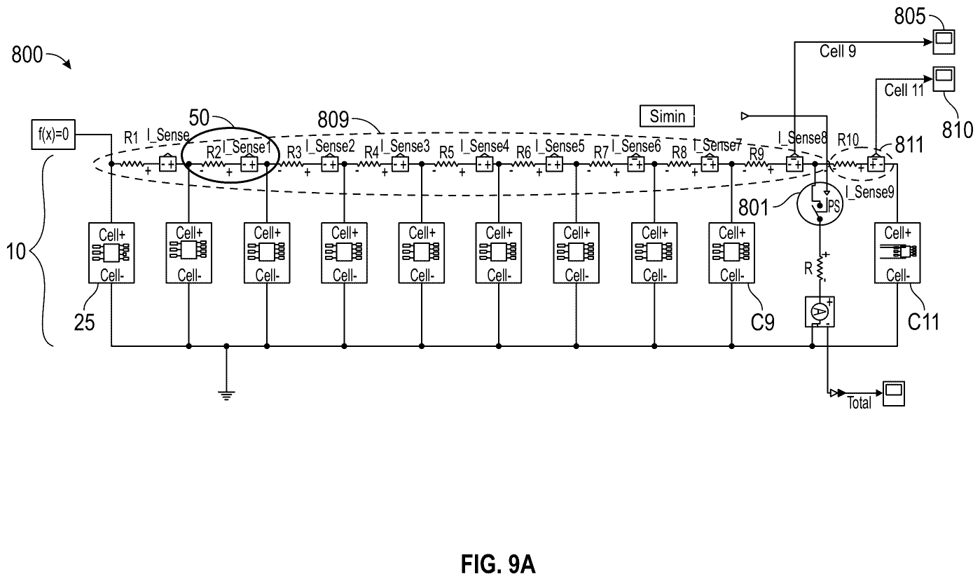

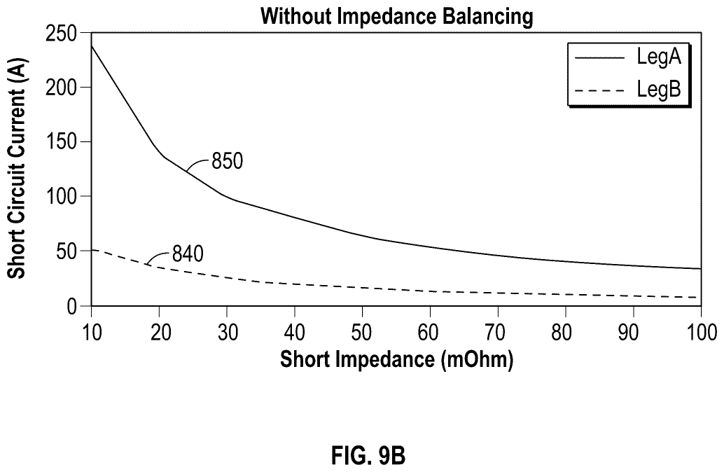

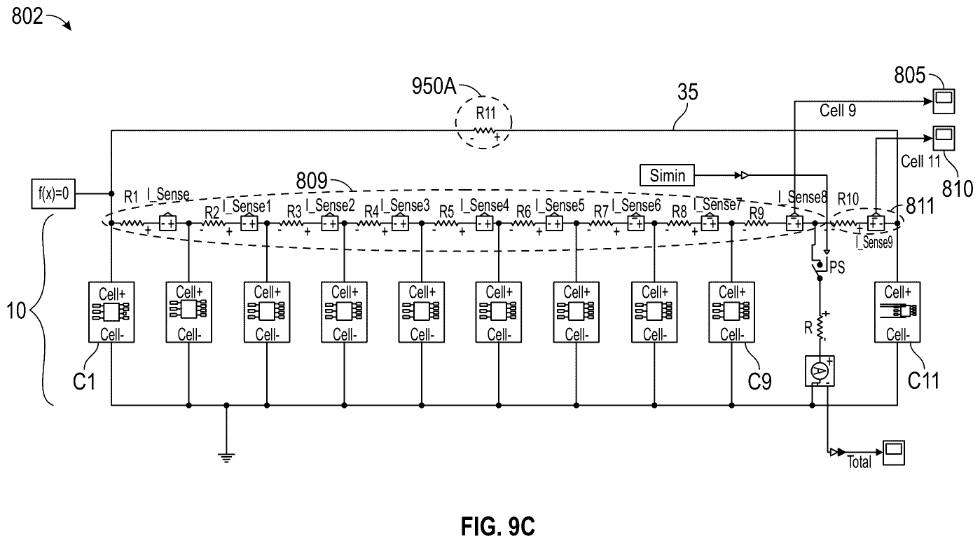

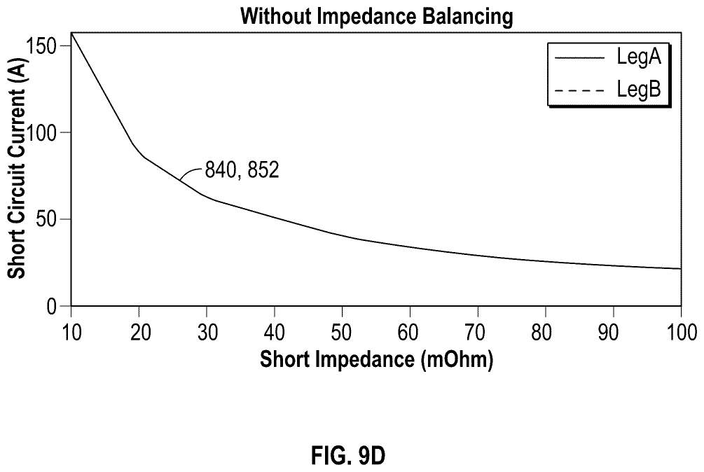

FIGS. 9A-9D depict a comparison of exemplary battery cell circuit configurations with and without an impedance balancing element for increasing reliability of multiple cell battery packs. In particular, FIG. 9A shows an equivalent circuit configuration 800 including a configuration 10 of eleven parallel-connected cells 25 and the serial π-connections of passive current limiting elements (fuses) 50 shown connected between adjacent terminal, e.g., positive terminals, of a single cell group 10 in a manner as shown in FIG. 1. It is understood that the π-connections of each fuse element can be connected between respective negative terminals of the cell group 10. In considering impedance balancing in such battery cell powered devices, the closing of a switch 801 simulates a short circuit of cell number 10. The resulting current running through cells 11 (“C11”) and cells 1-9 (“C9”) in response to the simulated short circuit of cell 25 by closing of switch 801 is measured at both current sensors 805 and 810, respectively. As shown in FIG. 9B, a simulating a short circuit condition at cell 10 upon closing of switch 801, it is shown that without impedance balancing, the short circuit current 850 (in amperes) detected through leg 809 including cells C1-C9 as measured by current sensor 805 is greater than the short circuit current 840 running through the leg 811 of remaining cell C11 as measured by current sensor 810. For example, as shown in FIG. 9B, for a 10 mOhm short circuit impedance at simulated shorted cell C10, current drawn at leg 809 from cells C1-C9 (e.g., 230 Amps) is much greater than the current draw through leg 811 through cell C11 (e.g., 50 Amps). These differences in current drawn from the two different cell groups illustrates the unpredictability of current flows when a cell is compromised in a multiple cell battery pack.

FIG. 9C shows an exemplary power cell (e.g., battery) circuit configuration 802 providing an impedance balancing element e.g., a wire conductor 35 (e.g., a “wrap around” wire) which itself may be or include a fuse 950A, connecting one (e.g., positive) terminal of a cell (e.g., cell C11) of the cell group 10 to the same terminal (e.g., positive terminal) of the first cell (e.g., cell “C1”) of the group 10 for increasing reliability and predictability of the current drawn should a short circuit arise at any of the multiple cells in the group. In particular, a presence of wire conductor 35 enables the balancing of the parallel short circuit current to every cell in the case of thermal runaway. As shown in FIG. 9D, the addition of wire conductor (or fuse) 35 increases reliability of the parallel fusing because the currents between each leg, e.g., the short circuit current 852 through leg 809 including cells 1-9 as measured by current sensor 805 becomes equal to the short circuit current 842 through leg 811 including cell 11 as measured by current sensor 810. For example, as shown in FIG. 9D, for a 10 mOhm short circuit impedance at simulated shorted cell C10, current drawn at leg 809 from cells C1-C9 (e.g., 150 Amps) is equal to the current draw through leg 811 through cell C11 (e.g., 150 Amps). The addition of wire conductor or fuse 35 connected at a parallel group of cells in the manner as shown in FIG. 9C causes an equalization of current through the serially connected fuses forming leg 809 and the fuse forming a leg 811 (e.g., current through leg 809 comprising cells C1-C9 equals current through the leg 811 comprising cell C11). This balanced current 852 through the serial connection of passive current limiting elements (fuses) at circuit leg 809 in the circuit 802 of FIG. 9C is decreased in value from the sensed current value 850 of leg 809 in the power cell circuit 800 without current balancing conductor 35; further balanced current 842 through the serial connection of passive current limiting elements (fuses) at leg 811 in the power cell circuit 802 is increased in value from the sensed current value 840 of leg 811 in the circuit 800 without current balancing wire conductor 35. This illustrates an increased predictability of current flows (e.g., short circuit current is balanced) when a cell is compromised in a multiple cell battery pack. Thus, for example, if the short circuit impedance of the shorted cell C10 is 25 mOhms and the current flow to cause propagation is 50A, then as shown in FIG. 9D, with current balancing, both circuit legs 809 and 811 will blow which is desirable as this total energy will be removed from the system, whereas in FIG. 9B only top circuit leg 809 will blow as the current through leg 811 through cell C11 is not enough to blow that leg (i.e., is <50A) and as a consequence, will continuously feed short circuit which will lead to thermal runaway. In an embodiment, the resistance and fusing characteristics of all resistors are ideally the same for increased predictability and robustness of the bridges, i.e., increasing the margin of protection of the parallel cell group from thermal runaway.

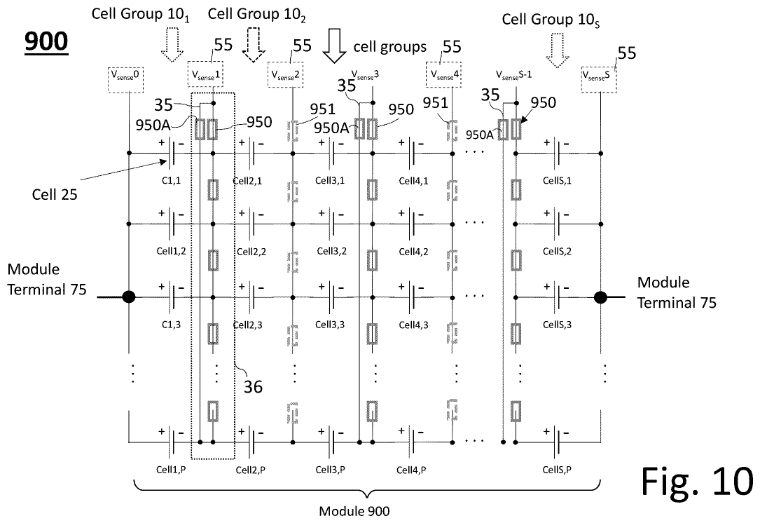

FIG. 10 shows schematic diagram of a power cell (e.g., battery) module 900 with thermal runaway protection and impedance balancing in accordance with aspects of the disclosure.

In particular, FIG. 10 illustrates an example of protection for thermal runaway using a passive current limiter 950 as shown in connection with FIG. 1 in accordance with aspects of the disclosure. In FIG. 10, as in FIG. 1, P cells are connected in parallel to form a cell group 10, where P is the number of parallelly connected cells. S groups of cells are connected in series, where S is the number of groups connected in series. The module 900 has S*P number of cells 25. The cells 25 are connected between module terminals 75. A passive current limiting element (current limiter or fuse 950A) is positioned in a parallel path of between the parallelly connected cells 25 of a cell group. As shown, parallel fuses 950 are provided only on the positive terminals of each group (1 needed to break current loop). It is understood that, for any given cell group, there does not have to be parallel fuses connecting all negative polarity terminals and positive polarity terminals. Thus, it is optional to provide any additional parallel fuses 951 connecting the negative terminals of the same group having parallel fuses on the positive terminals of that same group. In other embodiments, parallel fuses 950 can be provided only connected to the negative terminals of each group (and optionally the positive terminals). Thus, in the configuration of FIG. 10, any further fuses 951 along a parallel path of a cell group connecting negative terminals that already includes fuses 950 connecting positive terminal of that group is for redundancy. The fuses along a path do not limit current in the series path. In FIG. 10, the connection of passive current limiting elements 950, e.g., plural fuses shown connecting a group of cells have end terminals connected to both the positive and negative terminals of adjacent groups of the parallel connected cells (e.g., connect to both negative terminals of Cell group 10₁ and positive terminal of Cell group 10₂).

As further shown in FIG. 10, is the absence of parallel fuse group at the ends due to the presence of single module terminals 75 through which all current flows.

In some aspects of the disclosure, the passive current limiting element 950 is a fuse made of a conductive material. In some aspects of the disclosure, the fuse 950 may be integrated into a busbar 200A. A busbar is a structure, or assembly of sub-structures, which make electrical connections between elements.

As further shown in the FIG. 10, in the embodiment of the power cell module 900, there is provided impedance balancing conductor or wrap around wire 35 including a fuse 950A connecting one terminal of a fuse 950 of a first cell within a group (e.g., Cell group 10₁) to a terminal of a last fuse 950 within the same group (e.g., Cell group 10₁) to form a loop 36. Each wire conductor 35 (e.g., a fuse 950A) of module 900 of a loop 36 must have a fuse, or be sized to fuse in similar circumstances as the other parallel fuses. In the circuit configuration 900 of FIG. 10, the configuration of fuse elements 950 including impedance balancing or wrap around wire connector 35 along a respective group passively limits current in the parallel direction, does not limit current in the series path, balances parallel short circuit current to every cell in the case of thermal runaway, and reduces overall impedance for a battery management system (BMS) balancing current.

As further shown in FIG. 10, a voltage or current sensing circuit 55 is connected to detect the current through the parallel fuse connection in an individual cell group for continuity assurance. As shown in FIG. 10, a conductor portion of fuse 950 (or optional fuse 951) is shown extended for connection to a sensor, e.g., voltage sensing or current measurement circuit, e.g., a Vsense circuit 55. The battery management system will control Vsense circuit 55 to read a voltage of all the cells in a group, i.e., to ensure safe operation of the cells, estimates state-of-charge, etc.

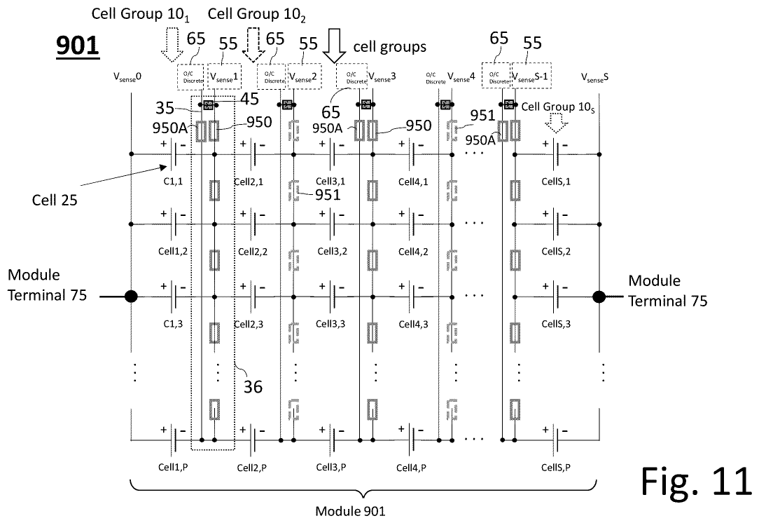

FIG. 11 shows circuit module 901 configured as the circuit module 900 of FIG. 10, however including a normally closed active switch device 45 to connect the impedance balancing wire connection 35 to the respective parallel connected fuses 950 of the cell group. In a cell group, the parallel-connected current limiting element 35 (e.g., fuse 950A) is connected to form a loop when active switch device 45 is closed, thus completing the loop 36. As in the embodiment depicted in FIG. 10, inclusion of any further fuses 951 along a parallel path such as the fuses connecting negative terminals of a cell group that already includes parallel fuses 950 connecting positive terminals of that same group is for redundancy. In the embodiment of FIG. 11, at each group 10 of parallel connected cells, the closed active switch 45, e.g., a programmable field effect transistor (FET) transistor, is activated open to break the loop to enable a check continuity of all the fuses 950 in the group. In an embodiment, an isolated Open/Closed discrete input or other input stimulus circuit 65 is controlled to open the switch to break the loop for open loop continuity testing. When active switch 45 is activated as closed, the power cell module 901 of FIG. 11 again functions identically to the power cell module 900 of FIG. 10. In such a configuration, current through parallel fuse in a cell group 10 can be sensed by Vsense circuitry 55 operatively connected to the BMS. For example, a processor of the BMS can operate to open the active switch 45 and open the loop, control the discrete stimulus circuit 65 and the sensing measurement circuitry 55 to measure the amount of current through or a voltage across the parallel connected fuses at the cell group 10 or employ any kind of discrete analog circuit that can detect continuity, such as an open/closed discrete input.

In the embodiment of FIG. 11, for continuity testing, parallel-connected impedance balancing wire connector 35 (e.g., a fuse) is connected to its respective cell group. By opening switch 45 and applying a voltage or current stimulus at O/C discrete circuit 65, there can be taken a current measurement by corresponding Vsense circuit 55 connected to the parallel busbar between two parallel fuses (e.g., the last parallel connected fuse 950) of a cell group for measuring the current through (or voltage at) the series of fuses 950 at the group. Optionally, a current or voltage measurement can be taken at the redundant series of fuses 951 of that parallel connected cell group. This current measurement can be used to detect any faulty fuse circuit within a cell group. This circuit configuration of module 902 allows for continuity testing of the parallel fuses. In the embodiment depicted in FIG. 11, the active switch device 45, e.g., FET, when closed, is at least capable of conducting currents equal to currents associated with thermal runaway induced short circuits, i.e., current the short is going to draw to cause the bridges to open.

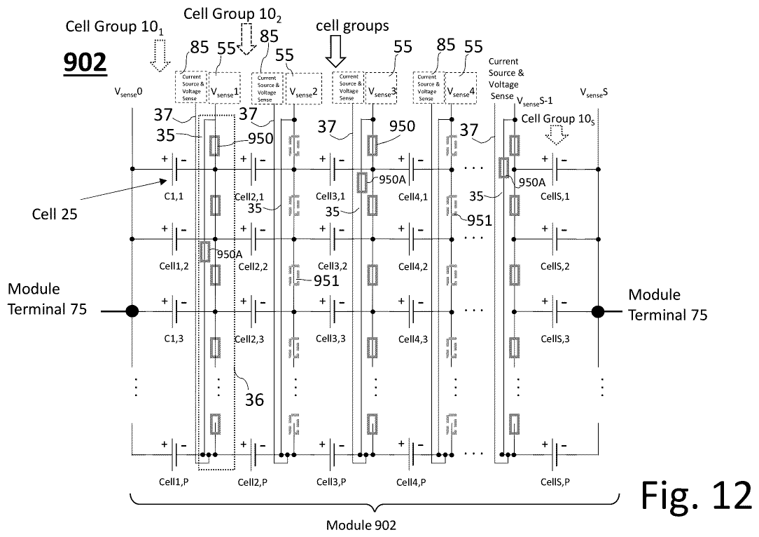

FIG. 12 shows the circuit module 902 similar to the circuit module 900 of FIG. 10 for providing continuity assurance according to a second embodiment, however, is passive, by not breaking the conductive loop 36 formed by the impedance balancing wrap around wire 35 (e.g., a fuse 950A) in parallel with each of connected fuses 950 in each group. As in the embodiment depicted in FIG. 10, any further fuses 951 along a parallel path of a cell group connecting negative terminals that already includes fuses 950 connecting positive terminals of that same group is for redundancy. In this embodiment, for continuity assurance, at each group 10 of cells, a separate conductor wire or trace 37 is provided connected to the loop 36 that can be used to apply a stimulus, i.e., a fixed current, to the parallel connected fuses 950 without breaking the loop 36 so as to enable a continuity check of all the fuses 950 in that cell group. The separate conductor or wire 37 is connected to a current source and voltage stimulus/sense circuit 85 to provide a fixed or constant current to a cell group 10 of power cell module 902 of FIG. 12. A continuity assurance measurement can then be taken that requires the measurement of a voltage drop across the cell group 10 by using Vsense circuitry 55, 85. Thus, both a discrete constant current stimulus circuit 85 and sensing measurement circuitry 55 can be employed to measure the amount of current through the parallel connected fuses at the cell group 10 without breaking loop 36. The further conductor or wire 37 connected at a respective cell group 10 is thus used for power cell module circuit sensing purposes performed by the BMS. By applying and measuring a voltage or current stimulus at circuit 85, there can be checked the continuity of all fuses in the group by a voltage divider logic. This current or voltage measurement can be used to detect any faulty fuse circuit within a cell group. This circuit configuration of module 902 allows for continuity testing of the parallel fuses of a cell group using the single trace 37 by measuring a small isolated current output with voltage monitor 85 (V=IR). The system will look for a voltage drop with a known impedance to obtain a known voltage drop. The continuity of all fuses in a group can be checked by means of voltage divider logic. That is, for any cell group, there is main leg of plural (e.g., 5) fuses and a single wrap around leg 35 of a single fuse which providing an unequal distribution of resistance. Given a constant current source and known resistance, ohms law requires a known voltage drop across these legs. Thus, for continuity assurance check, there can be applied a constant current stimulus and the voltage can be measured across voltage sense circuits 55, 85. Given the known resistances and currents, the analog voltage sense circuits can check the voltage drop and compare it to a threshold value indicative of a proper functioning cell for easy detection. This stimulus and measurement can be repeated for each Cell groups 10₁, . . . , Cell Group 10_{S} The voltage across the resistor network from one end to the other through its two legs will be greater with any of the parallel fuses broken than when they are unbroken. If any fuse is blown, the voltage measured across the resistor network will be higher than expected for a loop with all fuses intact.

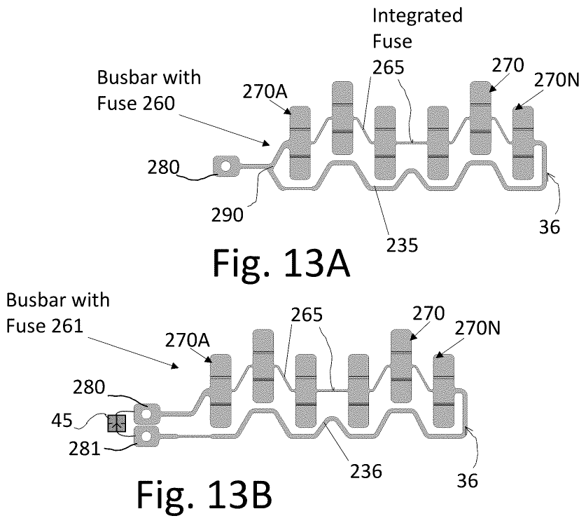

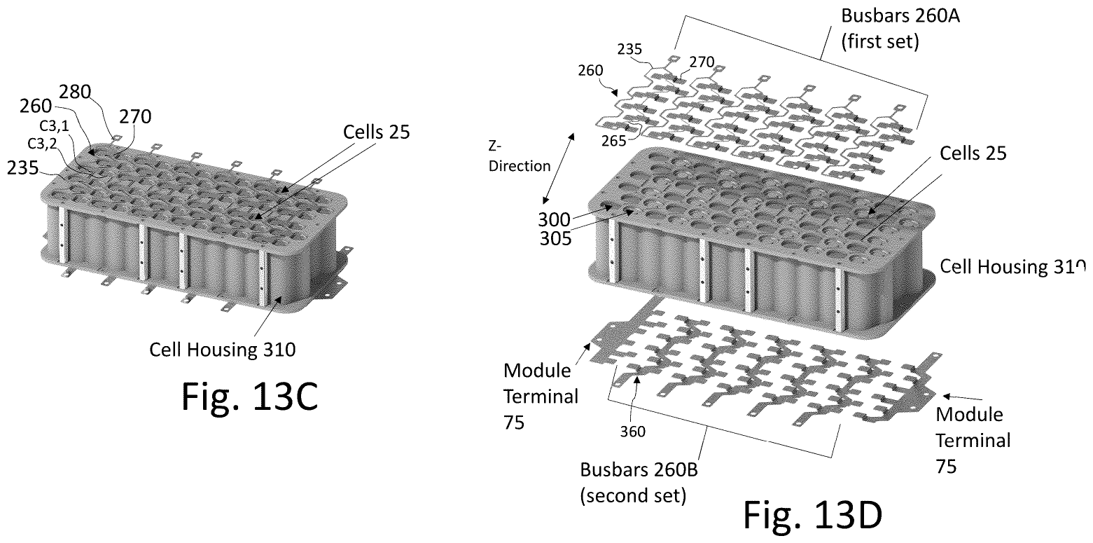

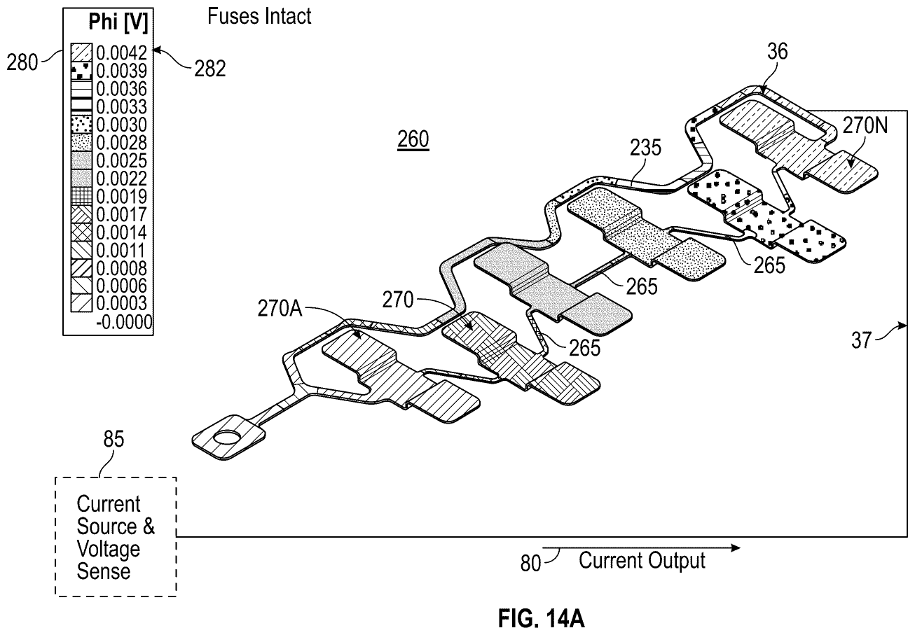

FIG. 13A illustrates an example busbar design 260 including an impedance balanced parallel fuse configuration with provision for continuity assurance verification. In the busbar design 260 with fuses of FIG. 13A, there is provided a first busbar portion or first “leg” including integrated fuses or bridges 265 integrated into the busbar 260. The busbar 260 is a structure, or assembly of sub-structures including metal tabs 270 which make electrical connections between elements, i.e., cell terminals of cells 25 in a module. The length of the fuse 265 may be based on the spacing between adjacent parallel cells in adjacent of a cell group (e.g., cells C1, 1 and C1, 2). The fuse 265 may be designed to force current flowing into a narrow geometry (width) to produce melting (cracking/breaking) to disconnect under the event conditions (such as thermal runway initiated parallel short circuit currents). A second portion or second leg of busbar 260 is itself an integrated fuse structure 235 that is connected to and extends from a first tab 270A associated with a first connected power cell of a cell group to a last tab 270N associated with a last power cell of that cell group and functions as the impedance balancing wrap around wire conductor forming a loop 36 with the portion including cell tabs 270 and integrated fuses 265. Busbar 260 further includes a conductive portion 280 shown extending from a physical join 290 of busbar first leg having tabs fuse portion with the second leg having integrated fuse structure 235 so as to facilitate connection to other circuitry, e.g., measurement or sensing circuitry for continuity assurance maintenance/verification.

FIG. 13B illustrates an example busbar design 261 according to an alternate embodiment corresponding to the embodiment of FIG. 11 that includes an impedance balanced parallel fuse configuration with provision for continuity assurance verification through active device 45. Like busbar 260, the busbar 261 includes a first leg of an assembly of sub-structures including metal tabs 270 which make electrical connections between elements, i.e., cell terminals of cells 25 in adjacent groups of the module, and connected fuse elements or bridges 265 therebetween. The length of the fuse 265 may be based on the spacing between adjacent parallel cells in adjacent of a group (e.g., cells C1, 1 and C1, 2). The fuse 265 may be designed to force current flowing into a narrow geometry (width) to produce melting (cracking/breaking) to disconnect under the event conditions (such as thermal runway initiated parallel short circuit currents). A second portion or second leg of busbar 261 is itself a fuse structure 236 that is connected to and extends from a tab 270N associated with a last connected power cell of the cell group and, through an activated switch device 45 such as a field effect transistor, connects to the first tab 270A to form the loop 36. The current limiting fuse structure 236 functions as the impedance balancing wrap around wire conductor when connected to form the loop 36 with the busbar portion including cell tabs 270 and integrated fuses 265. Busbar 261 further includes a first conductive portion 280 extending from the main busbar tabs fuse portion with integrated fuse portion 235 and further includes a second conductive portion 281 extending from the fuse structure 236. These conductive portions 280, 281 are not physically connected to each other, however, in this embodiment, conductive portions 280, 281 connect to active switch 45 which can be activated closed to form the loop 36 to provide impedance balancing. Such a configuration can be activated closed from an open state when conducting a continuity assurance of the busbar fuses as in the embodiment of FIG. 11. The active switch may be a normally closed switch that is capable of carrying the parallel short circuit current, but may be actively opened to perform continuity assurance testing.

FIG. 13C shows a combined assembly of a cell housing 310 having a plurality of power cells 25 and configured to include plural busbar with fuse structures 260 of FIG. 13A or the busbar fuse structure 261 of FIG. 13B. As shown in FIG. 13C, like cells of adjacent groups connect to respective sides of conductive tab 270 (e.g., adjacent cells C3, 1 of first group and cell C3, 2 of second group). The conductive portion 280 shown extending from busbar 260 beyond an edge of the cell housing 310 can connect to addition stimulus and sensing circuitry. FIG. 13C further depicts the integrated fuse structure 235 as a first conductive leg that extends from a first tab associated with a first connected power cell of a cell group to a last tab associated with a last power cell of the cell group and functions as the impedance balancing wire connection forming a loop with the other leg including cell tabs and integrated fuses. The busbar design could be incorporated into a PCB or a Laminated bus assembly as may be necessary for case of assembly, or to scale the module to high rate production.

In this aspect of the disclosure, FIG. 13D shows a physical connection of busbars 260, each busbar including a serial connection of tabs 270 connected in serial by fuse elements 265, each of the tabs connecting cells in parallel along two rows, each row having N cells (e.g., N=6). The busbar 260 also includes parallel connected impedance balancing conductor 235 such that impedance balancing is on one side of the assembly. Each busbar 260 tab connects a corresponding positive terminal 305 or negative terminal 300 of a cell 25 and has the fuse 265 in its parallel path between parallelly connected cells 25. In the example configuration shown in FIG. 13D, a first set 260A of busbars 260 is in connection with twelve (12) cells connecting two different terminals of adjacent cells along two row of cells: each busbar 260 parallelly connecting two sets of 6 cells and also serially connecting the two sets of cells with fuse elements. For each cell, in the first row, the busbar 260 includes first portion of tab 270 connected to the negative terminal 300 and in the second row, the second portion of the tab 270 is connected to the positive terminal 305 of the adjacent cell. In FIG. 13D, the first set 260A of busbars 260 at the top side of the module is designed to effect impedance balancing and continuity assurance only on the minimum locations in the module to protect every group.

Further, in the configuration of FIG. 13D, on the opposite (bottom) side of the cells 25 in the z direction, an optional second set 260B of busbar elements 360 are configured thicker with no integrated parallel fuses on this other module side. In an embodiment, the busbar element 360 connection of the tabs to cells in adjacent rows is offset by a row with respect to the tab connections of first set 260A of busbars 260. For example, a busbar 360 is connected to cells 25 in the second row and third row. This busbar 260 is connected to the negative terminal 300 of the cells in the second row and the positive terminal 305 of the cells in the third row. In an embodiment, the bottom side set 260B of busbars can include busbars 260, e.g., with impedance balancing wire, that can be connected to adjacent rows to form the redundant connection groups of cells.

The busbar assembly of FIGS. 13A-13D can be employed in energy storage systems in electric aircraft vehicles, such as for electric vertical take-off and landing, conventional take-off and landing, and for electric hybrid aircraft battery systems and electric or hybrid electric short takeoff and landing aircraft.

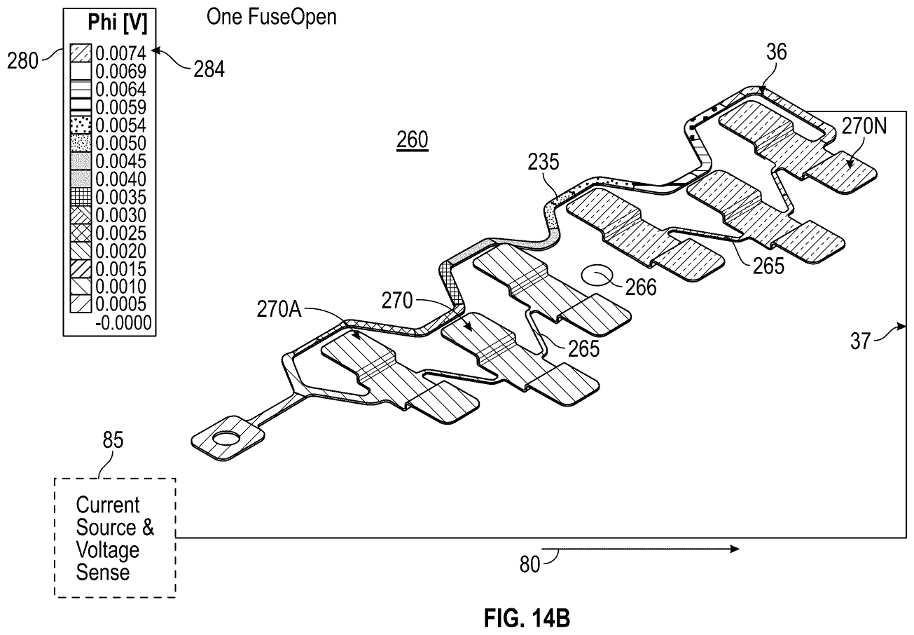

Referring to FIG. 14A, there is illustrated a passive test method using the busbar design 260 of FIG. 13A, e.g., according to the embodiment of FIG. 12, for continuity assurance. In FIG. 14A, the busbar 260 includes the loop 36 assembly of sub-structures including metal tabs 270 which make electrical connections between elements, i.e., cell terminals of cells 25 in adjacent groups of the module, and integrated fuse devices 265. In the embodiment of FIG. 14A, all fuses 265 are in tact. For continuity assurance, a current source and voltage sense circuit 85 is programmed by battery management system (BMS) to apply a test signal 80 to the loop 36 via the conductive wire or trace 37 and to measure a responsive voltage. The measure response voltage is either indicative of intact fuse of parallel fuse structures 235, 265 or is indicative of a parallel fuse being blown.

FIG. 14B illustrates a passive test method using the busbar design 260 according to the embodiment of FIG. 13A for continuity assurance, however showing an instance of one fuse being blown, i.e., broken or open fuse 266. In each of FIGS. 14A and 14B, the separate conductor wire or trace 37 is provided connected to the loop 36 that can be used to apply a stimulus, i.e., a fixed current, to the parallel connected fuses of loop 36 without breaking the loop 36 so as to enable a continuity check of all the parallel fuses 235, 265, in that cell group.

Illustrative of a method for continuity assurance testing, in an embodiment, the current source and voltage sense circuit 85 is programmed by battery management system (BMS) to apply a test signal 80 to the closed loop 36 via the conductive wire or trace 37. In an embodiment, test signal 80 can include a constant current signal from a constant current generator source. After application of test signal 80, voltage sense circuit 85 measures a voltage at the trace conductor 37. In an embodiment, this voltage is a voltage at the last tab 270N of the loop. The voltage is indicative of properly functioning cell group (no cells shorted or fuses blown) or, is indicative of a blown current limiting element or broken connection in the parallel path responsive to said sensed signal exceeding the threshold level.

For example, the parallel connection of first leg and second leg of busbar 260 forming a loop 36 is a parallel connection of respective resistances forming a two leg resistor network, e.g., the first leg having a first resistance R1 and the second leg having a second resistance of R2. During a continuity assurance test, after applying the current 80 across the loop 36, the voltage sense circuitry 85 measures the voltage at wire or trace 37. In the case of FIG. 14A, with no fuse element blown, the voltage read is the voltage at tab 270N, which is a voltage drop value of a distribution of voltage drops 280, corresponds to a voltage drop value 282, e.g., of about 4 mV, indicating correct operation of the cell group. In such an embodiment where the bridges are good, the total resistance of the two leg resistor network is

$${R}_{total} = \frac{1}{\frac{1}{{R}_{1}} + \frac{1}{{R}_{2}}} .$$

However, in view of FIG. 14B, given the blown fuse 266, after applying the test signal 80, e.g., a constant current signal, the voltage read is the voltage at tab 270N, which is a voltage drop value of a distribution of voltage drops 280, corresponds to a voltage drop value 284 of about 7 mV indicating a blown current limiting element (e.g., blown fuse or bridge 266) or broken connection in the parallel path of the cell group. For example, if one leg has a blown bridge 266 (one side is bad), the Rₜₒₜₐₗ=R1 while if the other leg has a blown bridge, the Rₜₒₜₐₗ=R2. Thus, in the non-limiting example of FIGS. 14A, B, the difference in voltage results when a parallel fuse is blown, e.g., 4 mV voltage is observed when all bridges are good, but a 7 mV voltage is observed when one bridge is bad. In the non-limiting example, upon testing and obtaining a voltage result, e.g., 7 mV, indicating a blown current limiting element (e.g., blown fuse or bridge 266), the BMS will flag this condition.

In an embodiment, for each of the embodiments of FIGS. 12-14, the BMS (not shown) can control a signal generating circuit and voltage sensing to conduct the same continuity assurance test for each cell group, e.g., in a sequence of parallel cell groups 10₁, . . . , 10_{S} of the battery module. Alternatively, the BMS can perform the same continuity assurance test for only non-redundant, e.g., alternating, cell groups that are configured with the impedance balancing wire connecting a parallel cell group. In addition, the BMS can perform the same continuity assurance test for any other redundant parallel cell group that is configured with the impedance balancing wire. Generally, upon testing and obtaining a voltage result indicating a blown current limiting element (e.g., blown fuse or bridge), the BMS will flag this condition, such as by logging this condition in a processor system memory. Additionally, the BMS can generate a signal for use in notifying a user or an entity the existence of a broken connection in a parallel path of the tested cell group. In an embodiment, the BMS does not lose connection to any of the parallel cells.

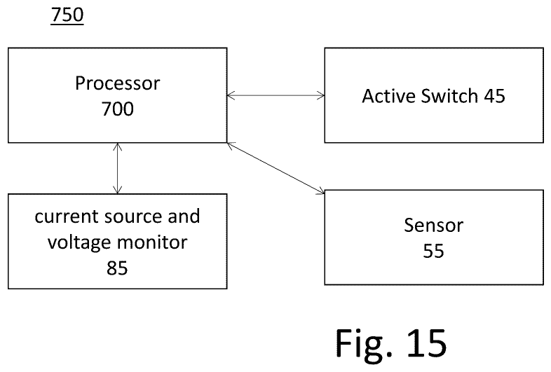

FIG. 15 illustrates a block diagram of a control system 750 configured to perform continuity assurance testing operations in accordance with the embodiments herein. In one aspect, the control system 750 includes a processor device 700 configured to control active switch device 45, e.g., when conducting a continuity assurance test, and/or to control operation other elements such as current source generators and sensors, such as voltage stimulus and sense elements 55, 85 and/or other devices, when conducting a continuity assurance testing in accordance with aspects of the disclosure.

The processor 700 may be an FPGA. In other aspects of the disclosure, the processor 700 may be a microcontroller or microprocessor or any other processing hardware such as a CPU or GPU. Memory may be separate from the processor (as or integrated in the same). For example, the microcontroller or microprocessor includes at least one data storage device, such as, but not limited to, RAM, ROM and persistent storage. In an aspect of the disclosure, the processor may be configured to execute one or more programs stored in a computer readable storage device. The computer readable storage device can be RAM, persistent storage or removable storage. A storage device is any piece of hardware that is capable of storing information, such as, for example without limitation, data, programs, instructions, program code, and/or other suitable information, either on a temporary basis and/or a permanent basis. The processor 700 may also include circuitry to bias or provide an analog signal to a gate or base of the semiconductor switch to cause the switch to open as needed or to a terminal of a contactor or relay.

In an aspect of the disclosure, the processor may be incorporated in a battery management system (BMS).

In an aspect of the disclosure, the processor 700 may include or control circuitry to bias or provide an analog signal to a gate or base of the semiconductor switch 45 to cause the switch to open/close as needed.

In an aspect of the disclosure, each active switch 45 may have its own dedicated processor.

The control system 750 of FIG. 15 further comprises the sensors 55, 85 used for continuity assurance testing. Other sensors controllable by processor 700 can include a voltage sensor, a current sensor, a temperature sensor, a gas sensor or any combination thereof. For example, temperature and/or gas sensors may be positioned adjacent to each cell 25 within the module 100, 900, 901 and 902. Voltage and/or current sensors may be connected to the cells 25 to measure the voltage and/or current, respectively. In described embodiments, voltage and/or current sensors may be connected to each of the parallel connected cells with thermal runaway protection and impedance balancing conductor forming a cell group connected to closed loop busbar 260 using a single trace for each of the number of cell groups connected in series.

In an aspect of the disclosure, the storage device may have threshold values associated with voltage drops for comparison when performing continuity assurance testing of the busbar fuse 260, 261 integrated with impedance balancing wire in each of the embodiments. For example, the storage device may have a voltage drop (ΔV) threshold above which, the processor 700 causes the flagging of this particular fuse or busbar, or cell group, based on a comparison of the sensed value with the ΔV threshold.

In an embodiment, when conducting continuity assurance testing in accordance with aspects of the disclosure, responsive to the processing of the sensed voltages, the processor 700 may issue a notification indicating a blown fuse or bridge condition by communicating the event electronically. Such notification may indicate the specific cell and/or fuse of the bridge of a cell group may be in need of maintenance or repair. The notification generated by the processor can flag the particular battery module to be brought in for service for replacement or troubleshooting.

As used herein, the term “processor” may include a single core processor, a multi-core processor, multiple processors located in a single device, or multiple processors in wired or wireless communication with each other and distributed over a network of devices, the Internet, or the cloud. Accordingly, as used herein, functions, features or instructions performed or configured to be performed by a “processor”, may include the performance of the functions, features or instructions by a single core processor, may include performance of the functions, features or instructions collectively or collaboratively by multiple cores of a multi-core processor, or may include performance of the functions, features or instructions collectively or collaboratively by multiple processors, where each processor or core is not required to perform every function, feature or instruction individually. For example, a single FPGA may be used or multiple FPGAs may be used to achieve the functions, features or instructions described herein.

Various aspects of the present disclosure may be embodied as a program, software, or computer instructions embodied or stored in a computer or machine usable or readable medium, or a group of media which causes the computer or machine to perform the steps of the method when executed on the computer, processor, and/or machine. A program storage device readable by a machine, e.g., a computer readable medium, tangibly embodying a program of instructions executable by the machine to perform various functionalities and methods described in the present disclosure is also provided, e.g., a computer program product.

The computer readable medium could be a computer readable storage device or a computer readable signal medium. A computer readable storage device, may be, for example, a magnetic, optical, electronic, electromagnetic, infrared, or semiconductor system, apparatus, or device, or any suitable combination of the foregoing; however, the computer readable storage device is not limited to these examples except a computer readable storage device excludes computer readable signal medium. Additional examples of the computer readable storage device can include: a portable computer diskette, a hard disk, a magnetic storage device, a portable compact disc read-only memory (CD-ROM), a random access memory (RAM), a read-only memory (ROM), an erasable programmable read-only memory (EPROM or Flash memory), an optical storage device, or any appropriate combination of the foregoing; however, the computer readable storage device is also not limited to these examples. Any tangible medium that can contain, or store, a program for use by or in connection with an instruction execution system, apparatus, or device could be a computer readable storage device.

A computer readable signal medium may include a propagated data signal with computer readable program code embodied therein, such as, but not limited to, in baseband or as part of a carrier wave. A propagated signal may take any of a plurality of forms, including, but not limited to, electro-magnetic, optical, or any suitable combination thereof. A computer readable signal medium may be any computer readable medium (exclusive of computer readable storage device) that can communicate, propagate, or transport a program for use by or in connection with a system, apparatus, or device. Program code embodied on a computer readable signal medium may be transmitted using any appropriate medium, including but not limited to wireless, wired, optical fiber cable, RF, etc., or any suitable combination of the foregoing.

In the discussion and claims herein, the term “about” indicates that the value listed may be somewhat altered, as long as the alteration does not result in nonconformance of the process or device. For example, for some elements the term “about” can refer to a variation of ±0.1%, for other elements, the term “about” can refer to a variation of ±1% or ±10%, or any point therein. For example, the term about when used for a measurement in mm, may include+/0.1, 0.2, 0.3, etc., where the difference between the stated number may be larger when the state number is larger. For example, about 1.5 may include 1.2-1.8, where about 20, may include 18.0-22.0.

As used herein, the term “substantially”, or “substantial”, is equally applicable when used in a negative connotation to refer to the complete or near complete lack of an action, characteristic, property, state, structure, item, or result. For example, a surface that is “substantially” flat would either completely flat, or so nearly flat that the effect would be the same as if it were completely flat. “Substantially” when referring to a shape or size may account for manufacturing where a perfect shapes, such as circular or sizes may be difficult to manufacture.

As used herein terms such as “a”, “an” and “the” are not intended to refer to only a singular entity, but include the general class of which a specific example may be used for illustration. As used herein, terms defined in the singular are intended to include those terms defined in the plural and vice versa.

References in the specification to “one aspect”, “certain aspects”, “some aspects” or “an aspect”, indicate that the aspect(s) described may include a particular feature or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

For purposes of the description hereinafter, the terms “upper”, “lower”, “right”, “left”, “vertical”, “horizontal”, “top”, “bottom”, and derivatives thereof shall relate to a device relative to a floor and/or as it is oriented in the figures or with respect to a surface.

Reference herein to any numerical range expressly includes each numerical value (including fractional numbers and whole numbers) encompassed by that range. To illustrate, reference herein to a range of “at least 50” or “at least about 50” includes whole numbers of 50, 51, 52, 53, 54, 55, 56, 57, 58, 59, 60, etc., and fractional numbers 50.1, 50.2 50.3, 50.4, 50.5, 50.6, 50.7, 50.8, 50.9, etc. In a further illustration, reference herein to a range of “less than 50” or “less than about 50” includes whole numbers 49, 48, 47, 46, 45, 44, 43, 42, 41, 40, etc., and fractional numbers 49.9, 49.8, 49.7, 49.6, 49.5, 49.4, 49.3, 49.2, 49.1, 49.0, etc.

The terminology used herein is for the purpose of describing particular embodiments only and is not intended to be limiting the scope of the disclosure and is not intended to be exhaustive. Many modifications and variations will be apparent to those of ordinary skill in the art without departing from the scope and spirit of the disclosure.

What is claimed is:

1. A battery module comprising:
a plurality of cells mounted within a housing, the housing having a plurality of openings respectively for a corresponding cell;
a plurality of groups of cells, each group comprises a plurality of parallel connected cells from among the plurality of cells, where the plurality of groups is connected in series; and
a plurality of current limiting elements, each current limiting element being electrically connected in a parallel path to one or both terminals of cells which are parallelly connected; and
a passive current limiting element associated with a corresponding group of cells, the passive current limiting element connected in parallel to the plurality of electrically connected current limiting elements in the parallel path.

2. The battery module of claim 1, wherein said passive current limiting element electrically connects a terminal of a first current limiting element to a terminal of another conductive limiting element in the parallel path.

3. The battery module of claim 1, wherein said passive current limiting element equalizes a parallel short circuit current flow to every cell of a corresponding group of cells to avoid propagation of thermal runaway caused by a short circuit of a cell of the group of cells.

4. The battery module of claim 2, wherein said passive current limiting element is a fuse.

5. The battery module of claim 4, wherein the passive current limiting element is of a same resistance as a resistance of a current limiting element of the plurality of current limiting elements.

6. The battery module of claim 3, wherein a corresponding passive current limiting element is associated with a corresponding group of cells of first alternating groups of cells, the corresponding passive current limiting element connected in parallel to a plurality of electrically connected current limiting elements in the parallel path of each of the corresponding group of cells of the first alternating group of cells.

7. The battery module of claim 6, further comprising: a redundant connection of a corresponding passive current limiting element associated with a corresponding group of cells of second alternating groups of cells, the redundant connection of the corresponding passive current limiting element connected in parallel to a plurality of electrically connected redundant current limiting elements in the parallel path of each of the corresponding group of cells of the second alternating group of cells.

8. The battery module of claim 3, further comprising:
a switching device connecting the passive current limiting element of an associated corresponding group of cells to a terminal of a first current limiting element in the parallel path.

9. The battery module of claim 7, wherein a corresponding passive current limiting element is associated with a corresponding group of cells of first alternating groups of cells, the corresponding passive current limiting element connected in parallel to a plurality of electrically connected current limiting elements in the parallel path of each of the corresponding group of cells of the first alternating group of cells.

10. The battery module of claim 7, further comprising:
a stimulus circuit connected to one end of the passive current limiting element connected in parallel to a plurality of electrically connected current limiting elements in the parallel path, said stimulus circuit applying a test signal for testing the parallel plurality of current limiting elements electrically connected in the parallel path; and
a sensing circuit connected to the terminal of the first current limiting element for sensing a signal flowing through the plurality of electrically connected current limiting elements in the parallel path responsive to the applied test signal, said sensed signal indicating one or more of: a condition of a blown current limiting element or a broken connection in said parallel path.

11. The battery module of claim 4, further comprising:
a trace conductor element connected to the passive current limiting element connected in parallel to the plurality of electrically connected current limiting elements in the parallel path;
a stimulus circuit connected to one end of the trace conductor element, said stimulus circuit applying a test signal for testing the parallel plurality of current limiting elements electrically connected in the parallel path; and
a sensing circuit connected to the terminal of the first current limiting element for sensing a signal flowing through the plurality of electrically connected current limiting elements in the parallel path responsive to the applied test signal, said sensed signal indicating one or more of: a condition of a blown current limiting element or a broken connection in said parallel path.

12. A method for testing a battery module comprising:
applying a test signal to one end of a passive current limiting element associated with a corresponding group of cells of a plurality of groups of cells mounted within a battery module housing, each group of cells comprising a plurality of parallel connected cells from among the plurality of cells, where the plurality of groups of cells is connected in series, each corresponding group of cells having a corresponding plurality of current limiting elements, each current limiting element being electrically connected in a parallel path to one or both terminals of cells which are parallelly connected, the passive current limiting element connected in parallel to a plurality of electrically connected current limiting elements in the parallel path, the test signal for testing the parallel plurality of current limiting elements electrically connected in the parallel path; and sensing, using a sensing circuit connected to the terminal of a first current limiting element, a signal flowing through the plurality of electrically connected current limiting elements in the parallel path responsive to the applied test signal, said signal indicating blown one or more of: a blown current limiting element or a broken connection in said parallel path.

13. The method as claimed in claim 12, wherein said passive current limiting element electrically connects a terminal of a first current limiting element to a terminal of another conductive limiting element in the parallel path.

14. The method as claimed in claim 12, further comprising:
equalizing, using the passive current limiting element, a distribution of current flow among cells of a corresponding group of parallel-connected cells in response to a short circuit of a cell in the corresponding group of parallel-connected cells to avoid a thermal runaway condition caused by the short circuit of the cell.

15. The method as claimed in claim 14, wherein said passive current limiting element and electrically connected current limiting elements is a fuse.

16. The method as claimed in claim 13, further comprising:
comparing, using a hardware processor, said sensed signal against a threshold level indicating a blown current limiting element or a broken connection in said parallel path; and
asserting, using the hardware processor, a signal indicating said one of a blown current limiting element or broken connection in said parallel path responsive to said sensed signal exceeding the threshold level.

17. The method as claimed in claim 14, wherein said battery module further comprises:
a switching device connecting the passive current limiting element of an associated corresponding group of cells to a terminal of a first current limiting element in the parallel path, said method further comprising:
programming said switching device, using the hardware processor, to form a loop comprising said plurality of current limiting elements and the passive current limiting element associated with a corresponding group of cells.

18. A busbar for a battery module having a plurality of battery cells, the busbar comprising:
a first conductive leg structure having a plurality of tab elements, each respective tab element having a first portion adapted to electrically connect a respective first type terminal of a respective first battery cell and a second portion adapted to electrically connect a respective second type terminal of a second battery cell to form a battery cell group comprising parallel-connected battery cells;
the first conductive leg structure further comprising plural integrated current limiting fuse portions, an integrated current limiting fuse portion connecting a tab element to form a series connection of alternating tab elements and integrated current limiting fuse portions connected therebetween; and
a second conductive leg structure adapted to connect to the first conductive leg structure in parallel to form a closed loop structure, the second conductive leg structure additionally comprising an integrated fuse structure.

19. The busbar as claimed in claim 18, wherein the battery module comprises a housing within which are disposed a plurality of rows of battery cells forming a plurality of batter cell groups, a said busbar adapted to connect to terminals of battery cells in two rows of battery cells to form a battery cell group, wherein a plurality of battery cell groups is connected in series in said housing.

20. The busbar as claimed in claim 18, whereby in the formed closed loop structure, the second conductive leg structure equalizing a parallel short circuit current flow to every connected cell in a corresponding group of cells in response to a short circuit of a cell of the corresponding group of cells to avoid propagating a thermal runaway condition from one battery cell to another battery cell.

21. The busbar as claimed in claim 20, further comprising:
an active switch device connected between an end of the first conductive leg structure and a corresponding end of the second conductive leg structure, said active switch device adapted to close to form the close loop structure or the active switch device adapted to open to break the closed loop structure.

22. The busbar as claimed in claim 18, further comprising:
a conductive trace structure connecting the formed closed loop structure, said conductive trace adapted for connection to a device configured for electronically checking a continuity of all integrated current limiting fuses in said busbar.
